(19) United States
(12) Patent Application Publication
(10) Pub. No.: US 2010/0176111 A1
(43) Pub. Date: Jul. 15, 2010

(54) VEHICLE HEATER SYSTEM AND METHOD

(75) Inventor: Michael Neisen, Ostrander, OH (US)

Correspondence Address: Rankin, Hill & Clark LLP, 23755 Lorain Road, Suite 200, North Olmsted, OH, 44070, US

(73) Assignee: Honda Motor Co., Ltd.

(21) Appl. No.: 12/354,100

(22) Filed: Jan. 15, 2009

(51) Int. Cl. B60L 1/02

(52) U.S. Cl. 219/205

(57) ABSTRACT

A heater system for a vehicle has an internal combustion engine fluidly connected to a fuel tank by a fuel line for delivering fuel from the fuel tank to the engine. The heater system includes an in-line heater disposed along the fuel line between the fuel tank and the internal combustion engine for heating fuel within the fuel line. A power cord is operatively connected to the in-line heater for providing electrical power thereto. The power cord has a distal end configured to removably connect to an external power source and a length sufficient to reach the external power source.

### BACKGROUND

The present disclosure generally relates to a vehicle heater system and method, and more particularly relates to a fuel heater powered by an external power source, and optionally an engine block heater powered together with the fuel heater by the external power source.

Starting a conventional internal combustion engine vehicle in low ambient temperatures, such as commonly found in colder climates, can be very difficult. This challenge increases with the use of flex fuel vehicles, such as those running on E-85 (i.e., alcohol fuel mixture of up to 85% denatured fuel ethanol and gasoline or other hydrocarbon), due to the nature of ethanol. Improving vehicle starting on flex fuel vehicles, and vehicles generally, results in increased customer satisfaction and reduced emissions. More particularly, by raising the temperature of a vehicle's engine and/or its fuel, combustion can begin sooner, resulting in faster starting of the vehicle. Also, less enrichment is required which results in lower emission levels.

One known device for warming a vehicle engine is a conventional block heater. Conventional block heaters are usually installed into a hole or aperture of the engine block otherwise occupied by a freeze plug. Block heaters are often provided with a power cord for electrically connecting to an external power source (i.e., a power source not carried on the vehicle). For example, most block heaters have a power cord with a plug at one end that removably connects to a conventional 110 Volt AC outlet for keeping the vehicle's engine block warm, such as overnight during vehicle storage.

Another known device that facilitates engine combustion, particularly when an engine is exposed to low ambient temperatures, is a vehicle fuel heater. In fact, many diesel vehicles have devices that heat the vehicle's fuel, however, these devices are usually powered by the vehicle, not an external power source. Typically, a DC electric heater and/or the vehicle's coolant is used to heat the fuel delivered to the engine or combustion thereof.

### SUMMARY

According to one aspect, an improved heater system is provided for a vehicle having an internal combustion engine fluidly connected to a fuel tank by a fuel line for delivering fuel from the fuel tank to the engine. More particularly, in accordance with this aspect, the heater system includes an inline heater disposed along the fuel line between the fuel tank and the internal combustion engine for heating fuel within the fuel line. The heater system further includes a power cord operatively connected to the in-line heater for providing electrical power thereto. The power cord has a distal end configured to removably connect to an external power source and a length sufficient to reach the external power source.

According to another aspect, an improved vehicle heater system is provided. More particularly, in accordance with this aspect, the vehicle heater system includes a fuel heater thermally connected to a fuel line for heating fuel carried by the fuel line from a fuel tank to an engine block. The vehicle heater system further includes a power cord electrically connected to the fuel heater. The power cord has a distal plug end connectable to an external power source for powering the fuel heater and heating the fuel carried by the fuel line.

According to still another aspect, a method of heating in a vehicle is provided. More particularly, in accordance with this aspect, an in-line heater mounted on a vehicle is provided for selectively heating fuel carried by a fuel line to an internal combustion engine. A power cord operatively connected to the in-line heater is provided for selectively providing power to the in-line heater. A plug end of the power cord is connected to an external power source to provide power to the in-line heater through the power cord.

### BRIEF DESCRIPTION OF THE DRAWINGS

FIG. 1 is a schematic diagram illustrating a heater system for a vehicle having an internal combustion engine fluidly connected to a fuel tank by a fuel line.

FIG. 2 is a schematic diagram illustrating another heater system for a vehicle having an Internal combustion engine fluidly connected to a fuel tank by a fuel line.

FIG. 3 is a flow diagram illustrating a method of heating in a vehicle, such as by the heater system of FIG. 1 or FIG. 2.

### DETAILED DESCRIPTION

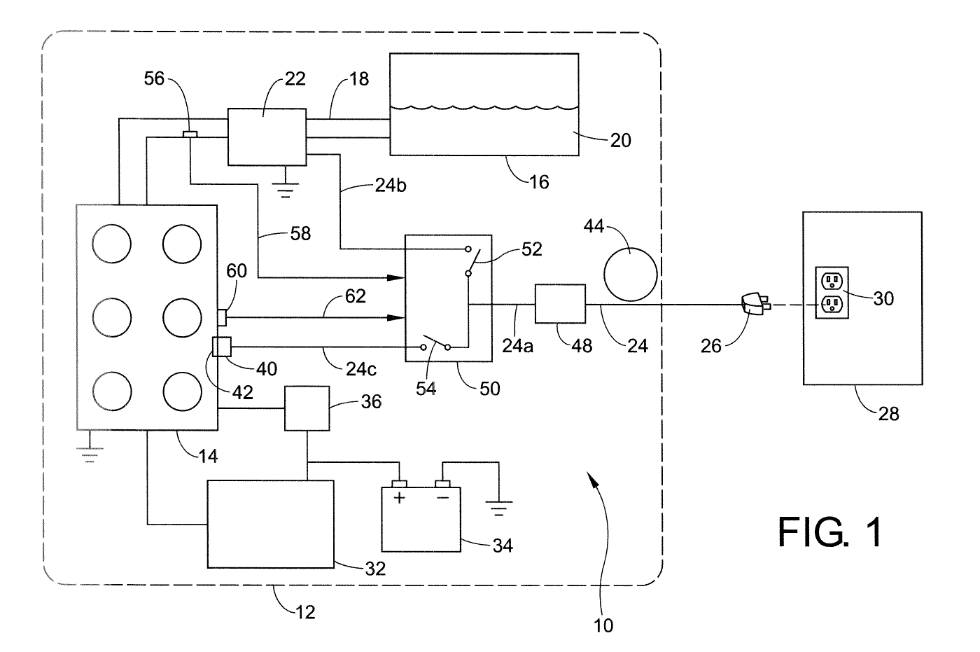

Referring now to the drawings, wherein the showings are only for purposes of illustrating one or more exemplary embodiments and not for limiting the same, FIG. 1 shows a vehicle heater system generally designated by reference numeral 10. In particular, the illustrated heater system 10 is for a vehicle 12 having an internal combustion engine 14 fluidly connected to a fuel tank 16 by a fuel line 18 for delivering fuel 20 from the fuel tank 16 to the engine 14. The heater system 10 includes a fuel heater 22 thermally connected to the fuel line 18 for heating fuel 20 carried by the fuel line 18 from the fuel tank 16 to the engine or engine block 14. The fuel heater 22 can be an in-line heater that is disposed along the fuel line 18 between the fuel tank 16 and the engine 14 for heating fuel 20 within the fuel line 18.

The heater system 10 further includes a power cord 24 operatively connected to the in-line heater 22 for providing electrical power thereto. The power cord 24 has a distal end 26 configured to removably connect to an external power source 28 and a length sufficient to reach the external power source 28. The external power source 28 is a power source not carried by the vehicle 12 and thus the power cord 24 is sufficient in length to extend from the vehicle 12 to the external power source 28 spaced apart from the vehicle. By way of example, the external power source can be an AC power source, such as a conventional 110 Volt AC power source having a standard wall outlet 30. In this arrangement, the distal end 26 of the power cord 24 can be a prong plug removably receivable in the outlet 30.

The engine 14 can be operatively connected to an ECU 32 as is known and understood by those skilled in the art. The vehicle 12 can also be equipped with an on-board battery 34 for providing power to the ECU 32 and also for starting the engine 14 via a conventional engine starting unit 36.

The vehicle heater system 10 can further include an engine block heater 40 that is thermally connected to the engine or engine block 14 for heating thereof. As shown in the illustrated embodiment, the block heater 40 can be disposed or mounted on the engine block 14. When both heaters 22,40 are included, the heater system 10 provides a combination block heater and fuel heater powered by the external power source 28. With the engine block heater 40, the power cord 24 is electrically connected to the fuel heater 22 and the engine block heater 40. Thus, when the distal plug end 26 of the power cord 24 is connected to the external power source 28, such as through wall outlet 30, the fuel heater 22 is powered by the power cord 24 for heating the fuel 20 carried in the fuel line 18 and the engine block heater is powered for heating the engine block 14. Like the in-line heater 22, the engine block heater 40 can be independently powered by the external power source 28 (i.e., not powered by the on-board battery 34). In one embodiment, the engine block heater 40 is received in a freeze plug aperture 42 of the engine 14 and the in-line fuel heater 22 is disposed within the fuel line 18 for heating the fuel 20 carried thereby. If desired, a spool 44 can be mounted on the vehicle 12 for spooling of the cord 24. More particularly, the cord 24 can be retracted and wound about the spool 44 when not in use and unwound from the spool 44 when it is desirable to connect the plug end 26 to the external power source 28.

The heater system 10 can also include a controller 50 disposed along the power cord 24 between the distal end 26 and the heaters 22,40 for selectively providing power from the external power source 28 to the heaters 22,40. As shown schematically, the controller 50 can be mounted on-board the vehicle 12 such that only a portion 24a of the power cord 24 extends from the vehicle 12 to the external power source 28. In one embodiment, the controller 50 includes at least one switch (e.g., switches 52,54) that is selectively closed by the controller 50 to provide power to one or both of the heaters 22,40 and selectively opened by the controller 50 to cease the provision of power to one or both of the heaters 22,40. In the illustrated embodiment, the controller 50 includes a first switch 52 that is selectively closed by the controller 50 to provide power to the in-line heater 22 and opened by the controller 50 to cease the provision of power to the in-line heater 22, and further includes a second switch 54 that is selectively closed by the controller 50 to provide power to the engine block heater 40 and opened by the controller 50 cease the provision of power to the engine block heater 40. Alternatively, though not illustrated, the controller 50 can include a single switch that is selectively closed and opened for powering and depowering both heaters 22,40 simultaneously or concurrently.

In the illustrated embodiment, the power cord 24 specifically includes the first portion 24a disposed between the controller 50 and the distal end 26, a portion of which can be wound about the spool 44 when included, and portions 24b,24c between the heaters 22,40 and the controller 50. If desired, a converter, such as an AC/DC converter 48 can be disposed along the power cord portion 24a. The portion 24b of the power cord 24 can be disposed between the controller 50 and the in-line heater 22, and specifically disposed downstream of the switch 52, for selectively powering the in-line heater 22. The portion 24c can likewise be provided between the controller 50 and the engine block heater 40, and particularly downstream of the switch 54, for selectively providing power to the engine blocked heater 40. By this arrangement, the controller 50 can independently and selectively provide power to each of the in-line heater 22 and the engine block heater 40.

The heater system 10 can additionally include at least one sensor for monitoring a temperature of the fuel 20, the internal combustion engine 14, ambient, and/or another vehicle component (e.g., battery 34). Such a sensor or sensors can send a temperature signal to the controller 50 representative of the temperature measured and the controller 50 can close one or more of its switches when the temperature signal indicates that the measured temperature is below a predetermined threshold temperature. More specifically, the at least one sensor can include a fuel sensor 56 in thermal contact with the fuel 20 and the fuel line 18 for measuring a temperature of the fuel. The fuel sensor 56 sends a fuel temperature signal 58 to the controller 50 indicating the measured temperature of the fuel. The controller 50 can then selectively close the in-line heater switch 52 when the temperature signal 58 indicates that the measured temperature of the fuel is below a predetermined threshold fuel temperature.

In addition, the at least one sensor can include an engine block sensor 60 in thermal contact with the engine block 14 for measuring a temperature of the engine block. The engine block sensor 60 can send an engine block temperature signal 62 to the controller 50 indicating the measured temperature of the engine. The controller 50 can close the engine block heater switch 54 when the engine block temperature signal 62 indicates that the temperature of the engine block 14 is below a predetermined engine block temperature. Alternatively, a sensor other than sensors 56,60 can be used (or can be used in addition to sensors 56,60). This other sensor could be a thermometer that measure ambient temperature or the temperature of another vehicle component, for example. If so used, the controller 50 could operate the in-line heater 22 and/or the engine block heater 40 based on the measured temperature from this other sensor or in conjunction with the sensors 56,60.

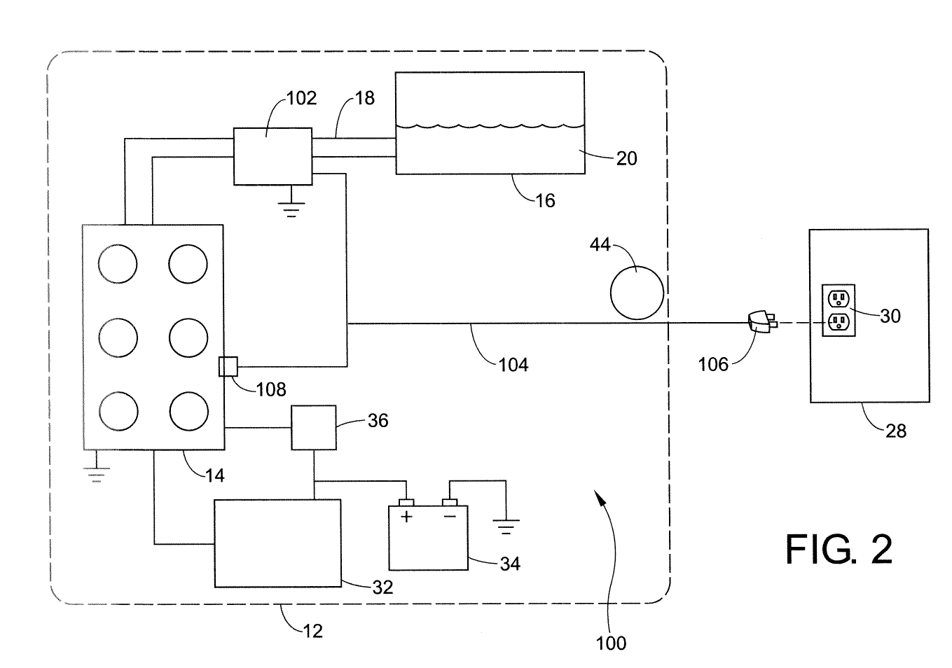

With reference now to FIG. 2, a vehicle heater system 100 is shown according to an alternate embodiment. Except as indicated below, the vehicle heater system 100 is similar to the vehicle heater system 10 and thus like reference numerals are used for like components. Like the system 10, the heater system 100 can be used on a vehicle 12 having internal combustion engine 14 fluidly connected to fuel tank 16 by fuel line 18, which delivers fuel from the fuel tank 16 to the engine or engine block 14. The heater system 100 includes an in-line heater 102 disposed along the fuel line 18 between the fuel tank 16 and the engine 14 for heating fuel within the fuel line. The in-line heater 102 can be the same as the heater 22 of FIG. 1.

The system 100 can also include a power cord 104. Similar to power cord 24, power cord 104 is electrically connected to the in-line heater 102 and has a distal plug end 106 removably connectable to external power source 28 via standard wall outlet 30 for powering the in-line heater 102 and heating the fuel 20 carried in the fuel line 18. The illustrated vehicle heater system 100 can also include an engine block heater 108 thermally connected to the engine block 14 for heating thereof, though this is not required. When included, the power cord 104 is electrically connected to the engine block heater 108 for powering the engine block heater and heating the engine block 14 when the distal plug end 106 is connected to the external power source 28. The engine block heater 108 can be the same as the engine block heater 40 of FIG. 1.

The vehicle heater system 100 of FIG. 2 is a simplified heater system relative to the heater system 10 of FIG. 1. In particular, the heater system 100 of FIG. 2 dispenses with the controller 50 and the sensors 56, 60 to provide a simplified heater system 100 that is constructed of relatively fewer parts or components. To operate the vehicle heater system 100, the plug end 106 is simply connected to the external power source 28 through the standard wall outlet 30. The power cord 104 then transmits electrical power from the external power source 28 to the heaters 102,108. When the plug end 106 is removed from the wall outlet 30, power is no longer provided to the heaters 102 and 108. If desired, spool 44 can be provided on board the vehicle 12 for winding of the power cord 104 when not in use as described in reference to the system 10 of FIG. 1.

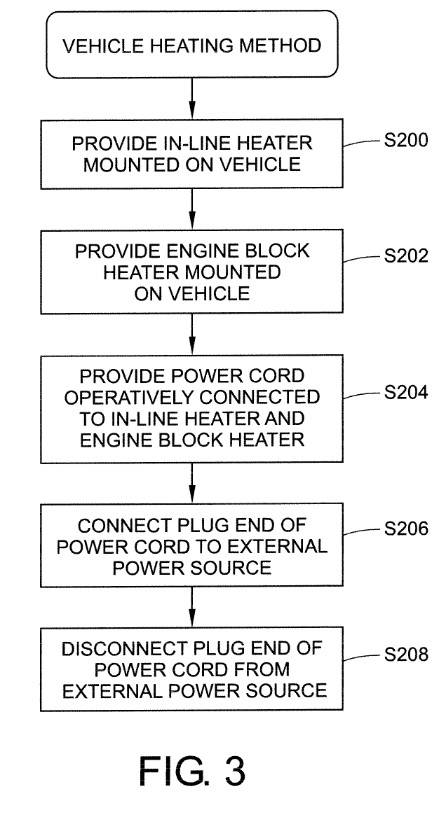

With reference to FIG. 3, a method of heating in a vehicle will now be described. As shown, in step S200 an in-line heater, such as heater 22 or 102, which is mounted on a vehicle, is provided for selectively heating fuel carried by a fuel line to an internal combustion engine. Optionally, in S202, an engine block heater, such as engine block heater 40 or 108, which is mounted on vehicle 10, is provided for selectively heating the internal combustion engine. In step S204, a power cord, such as power cord 24 or 104, which is operatively connected to the in-line heater provided in step S200 and to the engine block heater optionally provided in step S202, is provided for selectively providing power to the in-line heater. In step S206, to operate the heaters provided in steps S200 and S204, a plug end of the power cord is connected to an external power source, such as external power source 28, to provide power to the in-line heater through the power cord and to the engine block heater. When desirable to drive the vehicle 12, the plug end of the power cord is disconnected from the external power source 28 and can be carried on the vehicle, such via spool 44 (S208).

Advantageously, either of the systems 10 or 100 allow their heaters to be connected to a single external power source 28 through a single connector (e.g., plug in) as opposed to separate connectors. Thus, a single plug can connect to the external power source 28 to operate to heaters simultaneously. In a typical use, a vehicle owner will leave the vehicle 12 plugged in via the cord 24 or 104 overnight so the vehicle will start easily despite being subjected to cold ambient temperatures. By raising the temperature of the engine block 14 and of the fuel 20 delivered thereto, combustion can begin sooner thus starting the vehicle faster. In addition, less enrichment will be required in operation of the engine thereby lowering emission levels.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A heater system for a vehicle having an internal combustion engine fluidly connected to a fuel tank by a fuel line for delivering fuel from the fuel tank to the engine, the heater system comprising:
an in-line heater disposed along the fuel line between the fuel tank and the internal combustion engine for heating fuel within the fuel line; and
a power cord operatively connected to said in-line heater for providing electrical power thereto, said power cord having a distal end configured to removably connect to an external power source and a length sufficient to reach the external power source.

2. The heater system of claim 1 further including:
an engine block heater thermally connected to the internal combustion engine for heating thereof, said power cord also operatively connected to said engine block heater for providing power thereto such that connection of said distal end of said power cord to the external power source simultaneously provides power to both said in-line heater and said engine block heater.

3. The heater system of claim 2 wherein the engine block heater is received in a freeze plug aperture of the internal combustion engine.

4. The heater system of claim 1 wherein the external power source is an AC power source.

5. The heater system of claim 4 wherein the external power source is a 110 Volt AC power source having a standard wall outlet and said distal end of said power cord is a pronged plug removably received in said outlet.

6. The heater system of claim 1 further including:
a controller disposed along said power cord between said distal end and said in-line heater for selectively providing power to said in-line heater, said controller mounted on the vehicle.

7. The heater system of claim 6 wherein said controller includes at least one switch that is closed by said controller to provide power to said in-line heater and opened by said controller to cease the provision of power to said in-line heater.

8. The heater system of claim 7 further including:
a sensor mounted along the fuel line in thermal contact with the fuel within the fuel line for measuring a temperature of the fuel, said sensor sending a temperature signal to said controller indicating said temperature of the fuel, and said controller closing said switch when said temperature signal indicates that said temperature is below a predetermined threshold temperature.

9. The heater system of claim 6 further including:
a sensor mounted along the fuel line in thermal contact with the fuel within the fuel line for measuring a temperature of the fuel, said sensor sending a temperature signal to said controller indicating said temperature of the fuel, and said controller powering said in-line heater based on said temperature signal.

10. The heater assembly of claim 6 further including:
an engine block heater disposed on or in the internal combustion engine and operatively connected to said power cord for being powered thereby when said distal end is connected to the external power source, said controller independently selectively providing power to each of said in-line heater and said engine block heater.

11. The heater assembly of claim 10 wherein said controller includes at least one switch that is closed by said controller to provide power to one or both of said in-line heater and said engine block heater.

12. The heater assembly of claim 11 further including:
at least one sensor for monitoring a temperature of the fuel, the internal combustion engine, ambient, and/or another vehicle component, said at least one sensor sending a temperature signal to said controller representative of said temperature measured, said controller closing said at least one switch when said temperature signal indicates that said temperature is below a predetermined threshold temperature.

13. The heater assembly of claim 12 wherein said at least one switch includes:
an in-line heater switch that is selectively closed by said controller for powering said in-line heater; and
an engine block heater switch that is selectively closed by said controller for powering said engine block heater;
wherein said at least one sensor includes:
a fuel sensor in thermal contact with the fuel in the fuel line for measuring a temperature of the fuel, said fuel sensor sending a fuel temperature signal to said controller indicating the temperature of the fuel and said controller closing said in-line heater switch when said temperature signal indicates that said temperature of the fuel is below a predetermined threshold fuel temperature; and
an engine block sensor in thermal contact with the engine block for measuring a temperature of the engine block, said engine block sensor sending an engine block temperature signal to said controller indicating the temperature of the engine block and said controller closing said engine block heater switch when said engine block temperature signal indicates that said temperature of the engine block is below a predetermined engine block temperature.

14. The heater system of claim 10 further including:
a sensor mounted in thermal contact with the engine block for measuring a temperature of the engine block, said sensor sending a temperature signal to said controller indicating said temperature of the engine block, and the controller powering said engine block heater based on said temperature signal.

15. The heater system of claim 1 further including:
a spool mounted on the vehicle about which said power cord is wound when disconnected from the external power source.

16. A vehicle heater system, comprising:
a fuel heater thermally connected to a fuel line for heating fuel carried by said fuel line from a fuel tank to an engine block; and
a power cord electrically connected to said fuel heater and having a distal plug end connectable to an external power source for powering said fuel heater and heating said fuel carried in said fuel line.

17. The vehicle heater system of claim 16 further including:
a engine block heater thermally connected to said engine block for heating thereof, said power cord electrically connected to said engine block heater for powering said engine block heater and heating said engine block when said distal plug end is connected to said external power source.

18. The vehicle heater system of claim 17 wherein said fuel heater is an in-line fuel heater disposed within said fuel line for heating said fuel carried by said fuel line when powered and said engine block heater is freeze plug heater received within a freeze plug of said engine block for heating said engine block when powered.

19. A method of heating in a vehicle, comprising:
providing an in-line heater mounted on a vehicle for selectively heating fuel carried by a fuel line to an internal combustion engine;
providing a power cord operatively connected to said in-line heater for selectively providing power thereto; and
connecting a plug end of said power cord to an external power source to provide power to said in-line heater through said power cord.

20. The method of claim 19 further including:
providing an engine block heater mounted on said vehicle for selectively heating said internal combustion engine, said power cord operatively connected to said engine block heater for selectively providing power thereto when said plug end is connected to said external power source to heat said internal combustion engine.

21. The method of claim 19 further including:
disconnecting said plug end of said power cord from said external power source and carrying said power cord on said vehicle.
